(19) United States
(12) Patent Application Publication
(10) Pub. No.: US 2025/0286043 A1
(43) Pub. Date: Sep. 11, 2025

(54) NEGATIVE ELECTRODE PLATE, SECONDARY BATTERY, AND ELECTRONIC APPARATUS

(71) Applicant: Xiamen Ampace Technology Limited, Xiamen (CN)

(72) Inventors: Songyang SU, Xiamen (CN); Zehan LIU, Xiamen (CN)

(73) Assignee: Xiamen Ampace Technology Limited, Xiamen (CN)

(21) Appl. No.: 19/072,222

(22) Filed: Mar. 6, 2025

(30) Foreign Application Priority Data
Mar. 6, 2024 (CN) 202410256651.0

(51) Int. Cl. H01M 4/134; H01M 4/02; H01M 4/133; H01M 4/36; H01M 4/38; H01M 4/48; H01M 4/587; H01M 4/62

(52) U.S. Cl. CPC H01M 4/134; H01M 4/133; H01M 4/364; H01M 4/386; H01M 4/483; H01M 4/587; H01M 4/622; H01M 4/625; H01M 2004/027

(57) ABSTRACT

A negative electrode plate includes a negative electrode current collector, as well as a first active substance layer and a second active substance layer disposed on at least one surface of the negative electrode current collector. In a thickness direction of the negative electrode plate, the second active substance layer is disposed between the negative electrode current collector and the first active substance layer. The first active substance layer includes a first active material and a first binder, the first active material includes a first silicon material, and the first binder includes a PAA binder. The second active substance layer includes a second active material and a second binder, the second active material includes a second silicon material, and the second binder includes an SBR binder. A mass percentage of the first silicon material is P1, and a mass percentage of the second silicon material is P2, where P2<P1.

### CROSS-REFERENCE TO RELATED APPLICATIONS

This application claims the priority of Chinese Application No. 202410256651.0, filed on Mar. 6, 2024, the contents of which is incorporated herein by reference in its entirety.

### TECHNICAL FIELD

This application relates to the field of electrochemical technologies, and in particular, to a negative electrode plate, a secondary battery, and an electronic apparatus.

### BACKGROUND

Secondary batteries, such as lithium-ion batteries, have advantages such as high energy storage density, high open-circuit voltage, low self-discharge rate, long cycle life, and high safety, and therefore are currently widely used as a power source in electronic products such as cameras, mobile phones, drones, notebook computers, and smart watches.

As increasingly high requirements are imposed on the energy density of lithium-ion batteries, silicon negative electrodes have gradually become an important direction of the development of lithium-ion batteries. Silicon materials, as a negative electrode active substance of lithium-ion batteries, can increase the energy density of lithium-ion batteries, but cause problems such as insufficient kinetic performance, narrow charge window, impedance increase and consequent significant discharge temperature rise of the lithium-ion batteries due to poor electronic conductivity and ion transport properties of silicon materials. In addition, during lithium ion intercalation and deintercalation, silicon materials undergo a large volume change, leading to significant volume swelling of lithium-ion batteries, thus resulting in poor adhesion performance of silicon negative electrodes and fast cycling degradation of lithium-ion batteries.

### SUMMARY

This application is intended to provide a negative electrode plate, a secondary battery, and an electronic apparatus, so as to improve the kinetic performance and cycling stability of secondary batteries. Specific technical solutions are as follows.

According to a first aspect, this application provides a negative electrode plate including a negative electrode current collector, as well as a first active substance layer and a second active substance layer disposed on at least one surface of the negative electrode current collector. In a thickness direction of the negative electrode plate, the second active substance layer is disposed between the negative electrode current collector and the first active substance layer. The first active substance layer includes a first active material and a first binder, the first active material includes a first silicon material, and the first binder includes a polyacrylic acid (PAA) binder. The second active substance layer includes a second active material and a second binder, the second active material includes a second silicon material, and the second binder includes a styrene-butadiene rubber (SBR) binder. A mass percentage of the first silicon material in the first active substance layer is P1, and a mass percentage of the second silicon material in the second active substance layer is P2, where P2<P1. A particle size Dᵥ50 of the first silicon material is D1, and a particle size Dᵥ50 of the second silicon material is D2, where D1<D2. In this application, the first active substance layer and the second active substance layer are disposed on at least one surface of the negative electrode current collector, and the first active substance layer farther away from the negative electrode current collector uses a silicon material with higher percentage and smaller particle size and a PAA binder with better adhesion performance, improving the ion transport efficiency and improving the kinetic performance of the active material of the first active substance layer. In addition, the PAA binder can form strong hydrogen bonds with the silicon material to provide a large adhesion force, thereby ensuring the stability of the first active substance layer during cycling. The second active substance layer closer to the negative electrode current collector uses a silicon material with lower percentage and larger particle size and an SBR binder with better kinetic performance, enhancing the capability of the second active substance layer participating in lithium ion intercalation and deintercalation, effectively improving lithium ion transport efficiency in a negative electrode of the secondary battery, and also alleviating the problems such as significant swelling of the silicon-containing negative electrode plate, thereby allowing the secondary battery to have both good kinetic performance and cycling stability.

In an embodiment of this application, 0.1%≤P2<P1≤30%. In this application, controlling the percentage of the first silicon material in the first active substance layer to be within the foregoing range can effectively improve the ion transport efficiency, thereby improving the kinetic performance of the secondary battery. In addition, the PAA binder can form strong hydrogen bonds with the silicon material to provide a large adhesion force, thereby ensuring the stability of the first active substance layer during cycling. The percentage of the second silicon material in the second active substance layer is controlled to be within the foregoing range, and the low-percentage silicon material and the SBR binder are combined for use in the second active substance layer, improving the kinetic performance of the silicon material in the second active substance layer away from an electrolyte. This ensures the kinetic performance of the secondary battery and the stability of the negative electrode plate during cycling, thereby improving the kinetic performance and cycling stability of the secondary battery.

In an embodiment of this application, 1 μm≤D1<D2≤30 μm. Controlling the particle size Dᵥ50 of the first silicon material in the first active substance layer and the particle size Dᵥ50 of the second silicon material in the second active substance layer to be within the range provided in this application can further improve the ion transport efficiency, thereby improving the kinetic performance of the secondary battery and also ensuring the cycling stability of the secondary battery.

In an embodiment of this application, the first active substance layer further includes a first dispersant, the first dispersant includes a first carboxymethyl cellulose (CMC) dispersant, and a mass percentage F1 of the first dispersant in the first active substance layer is 0.1% to 5%; and/or the second active substance layer further includes a second dispersant, the second dispersant includes a second carboxymethyl cellulose dispersant, and a mass percentage F2 of the second dispersant in the second active substance layer is 0.1% to 5%. The use of the foregoing type of dispersant with the foregoing percentage and the combined use of the PAA binder and CMC dispersant in the first active substance layer can improve the stability of the first active substance layer during cycling, thereby improving the kinetic performance of the secondary battery and also ensuring the cycling stability of the secondary battery. The use of the foregoing type of dispersant with the foregoing percentage and the combined use of the low-percentage silicon material, the SBR binder with good kinetic performance, and the CMC dispersant in the second active substance layer can improve the kinetic performance of the silicon material in the second active substance layer away from the electrolyte, thereby improving the kinetic performance of the secondary battery. The use of both the foregoing types of first dispersant and second dispersant within the foregoing percentage ranges can better exert a synergistic effect of the first active substance layer and the second active substance layer, thereby further improving the kinetic performance and cycling stability of the secondary battery.

In an embodiment of this application, 1 μm≤D1≤8 μm, and/or 8 μm<D2≤30 μm. In this application, the particle size Dᵥ50 of the first silicon material in the first active substance layer is controlled to be within the foregoing range, so that the silicon material with smaller particle size has a larger specific surface area and more active sites for reaction, thereby accelerating ion transport and improving the kinetic performance of the secondary battery. In addition, the use of the PAA binder with good adhesion performance reduces expansion of the silicon material, thereby improving swelling resistance of the silicon-containing negative electrode plate and improving the cycling stability of the secondary battery. Controlling the particle size Dᵥ50 of the second silicon material in the second active substance layer to be within the foregoing range and using the SBR binder with good kinetic performance can improve the kinetic performance of the second active material, thereby improving the kinetic performance of the secondary battery. In addition, controlling both the particle size Dᵥ50 of the first silicon material and the particle size Dᵥ50 of the second silicon material to be within the foregoing ranges can better exert a synergistic effect of the first active substance layer and the second active substance layer, thereby further improving the kinetic performance and cycling stability of the secondary battery.

In an embodiment of this application, a ratio of the particle size Dᵥ50 to a particle size Dᵥ90 of the first silicon material is G1, satisfying 0.55<G1≤0.7; and/or a ratio of the particle size Dᵥ50 to a particle size Dᵥ90 of the second silicon material is G2, satisfying 0.5≤G2≤0.55. In this application, controlling the particle size Dᵥ50/Dᵥ90 of the first silicon material to be within the foregoing range and using the PAA binder with good adhesion performance can better exert the ion transport performance of the silicon material and the adhesion performance of the binder, ensuring both the kinetic performance and swelling resistance of the negative electrode plate, thereby improving the kinetic performance and cycling stability of the secondary battery. Controlling the particle size Dᵥ50/Dᵥ90 of the second silicon material to be within the foregoing range and using the SBR binder with good kinetic performance can enhance lithium ion intercalation and deintercalation capability of the second active material and reduce influence on an expansion volume of the second silicon material, thereby improving the kinetic performance and cycling stability of the secondary battery. Controlling both the particle size Dᵥ50/Dᵥ90 of the first silicon material and the particle size Dᵥ50/Dᵥ90 of the second silicon material to be within the foregoing ranges can better exert a synergistic effect of the first silicon material and the PAA binder and a synergistic effect of the second silicon material and the SBR binder, thereby further improving the kinetic performance and cycling stability of the secondary battery.

In an embodiment of this application, the first active material further includes first graphite, and based on a total mass of the first active material, a mass percentage A1 of the first silicon material is 1% to less than 100%, and a mass percentage B1 of the first graphite is greater than 0% to 99%; and/or the second active material further includes second graphite, and based on a total mass of the second active material, a mass percentage A2 of the second silicon material is greater than 0% to 99%, and a mass percentage B2 of the second graphite is 1% to less than 100%. In an embodiment of this application, the mass percentage A1 of the first silicon material is 15% to less than 100%, and the mass percentage B1 of the first graphite is greater than 0% to 85%; and/or the mass percentage A2 of the second silicon material is 1% to 15%, and the mass percentage B2 of the second graphite is 85% to 99%. Controlling the percentage A1 of the first silicon material and the percentage B1 of the first graphite to be within the foregoing ranges can effectively improve the ion transport efficiency in a final discharging stage, thereby improving the kinetic performance of the secondary battery. In addition, the silicon material increases a cycling swelling rate of the negative electrode plate. The combination with the PAA binder for use allows the first active substance layer to have good stability during cycling, thereby allowing the secondary battery to have both good kinetic performance and cycling stability. Controlling the percentage A2 of the second silicon material and the percentage B2 of the second graphite to be within the foregoing ranges and using the SBR binder with good kinetic performance can improve the kinetic performance of the silicon material in the second active substance layer farther away from the electrolyte, thereby improving the kinetic performance of the secondary battery. Controlling the percentage A1 of the first silicon material, the percentage B1 of the first graphite, the percentage A2 of the second silicon material, and the percentage B2 of the second graphite to be all within the foregoing ranges can exert a synergistic effect of the first active substance layer and the second active substance layer, thereby improving the kinetic performance and cycling stability of the secondary battery.

In an embodiment of this application, a mass percentage N1 of the first binder in the first active substance layer is 1% to 10%; and/or a mass percentage N2 of the second binder in the second active substance layer is 1% to 10%. Controlling the percentage of the first binder to be within the range provided in this application can better exert a synergistic effect of the first silicon material and the first binder, ensuring both kinetic performance and cycling swelling resistance of the negative electrode plate, thereby allowing the secondary battery to have both good kinetic performance and cycling stability. Controlling the percentage of the second binder to be within the range provided in this application can better exert a synergistic effect of the second silicon material and the second binder, further improving the kinetic performance of the negative electrode plate, thereby further improving the kinetic performance of the secondary battery. Controlling the percentages of the first binder and the second binder to be within the foregoing ranges can further exert the synergistic effect of the first active substance layer and the second active substance layer, thereby further improving the kinetic performance and cycling stability of the secondary battery.

In an embodiment of this application, the first active substance layer further includes a first conductive agent, and a mass percentage C1 of the first conductive agent in the first active substance layer is 0.1% to 5%; and/or the second active substance layer further includes a second conductive agent, and a mass percentage C2 of the second conductive agent in the second active substance layer is 0.1% to 5%. In this application, controlling the percentage of the first conductive agent to be within the foregoing range can improve the kinetic performance of the first active substance layer, thereby improving the kinetic performance of the secondary battery. Controlling the percentage of the second conductive agent to be within the foregoing range can improve the kinetic performance of the second active substance layer, thereby improving the kinetic performance of the secondary battery. Controlling both the percentages of the first conductive agent and the second conductive agent to be within the foregoing ranges can further exert the synergistic effect of the first active substance layer and the second active substance layer, thereby further improving the kinetic performance of the secondary battery.

In an embodiment of this application, the polyacrylic acid binder includes at least one of polyacrylic acid or polymethacrylic acid. Using the foregoing PAA binder in the first active substance layer helps to exert a synergistic effect of the first silicon material and the PAA binder, improving the kinetic performance and cycling swelling resistance of the first silicon material, thereby helping to improve the kinetic performance and cycling stability of the secondary battery.

In an embodiment of this application, the styrene-butadiene rubber binder includes at least one of styrene-butadiene rubber emulsion, styrene-acrylate emulsion, or pure acrylate emulsion. Using the foregoing SBR binder in the second active substance layer helps to exert a synergistic effect of the second silicon material and the SBR binder, improving the kinetic performance of the second silicon material, thereby helping to improve the kinetic performance of the secondary battery.

In an embodiment of this application, the first silicon material and the second silicon material each independently include at least one of pure silicon, a silicon alloy material, a silicon-carbon composite material, or a silicon oxide. In this application, the use of the foregoing types of silicon materials helps to exert a synergistic effect of the silicon material and the PAA binder and a synergistic effect of the silicon material and the SBR binder and helps to improve the kinetic performance and cycling swelling resistance of the negative electrode plate, thereby helping to improve the kinetic performance and cycling stability of the secondary battery.

According to a second aspect, this application provides a secondary battery including the negative electrode plate according to any one of the foregoing embodiments. The secondary battery according to the second aspect of this application has good kinetic performance and cycling stability.

According to a third aspect, this application provides an electronic apparatus including the secondary battery according to any one of the foregoing embodiments.

This application has the following beneficial effects.

This application provides a negative electrode plate, a secondary battery, and an electronic apparatus. The negative electrode plate includes a negative electrode current collector, as well as a first active substance layer and a second active substance layer disposed on at least one surface of the negative electrode current collector. In a thickness direction of the negative electrode plate, the second active substance layer is disposed between the negative electrode current collector and the first active substance layer. The first active substance layer includes a first active material and a first binder, the first active material includes a first silicon material, and the first binder includes a polyacrylic acid binder. The second active substance layer includes a second active material and a second binder, the second active material includes a second silicon material, and the second binder includes a styrene-butadiene rubber binder. A mass percentage of the first silicon material in the first active substance layer is P1, and a mass percentage of the second silicon material in the second active substance layer is P2, where P2<P1. A particle size Dᵥ50 of the first silicon material is D1, and a particle size Dᵥ50 of the second silicon material is D2, where D1<D2. In this application, the first active substance layer and the second active substance layer are disposed on the negative electrode current collector, the first active substance layer farther away from the negative electrode current collector uses a silicon material with higher percentage and smaller particle size and a PAA binder with better adhesion performance, and the second active substance layer closer to the negative electrode current collector uses a silicon material with lower percentage and larger particle size and an SBR binder with better kinetic performance, effectively improving lithium ion transport efficiency in a negative electrode of the secondary battery, and also alleviating the problems such as significant swelling of the silicon-containing negative electrode plate, thereby ensuring the cycling stability of the secondary battery while improving the kinetic performance of the secondary battery, and allowing the secondary battery to have both good kinetic performance and cycling stability.

Certainly, when any product or method of this application is implemented, all advantages described above are not necessarily demonstrated simultaneously.

### BRIEF DESCRIPTION OF DRAWINGS

To describe the technical solutions in some embodiments of this application or in the prior art more clearly, the following briefly describes the accompanying drawings for describing these embodiments or the prior art. Apparently, the accompanying drawings in the following description show merely some embodiments of this application, and persons of ordinary skill in the art may still derive other embodiments from these accompanying drawings.

FIG. 1 shows a negative electrode plate according to an embodiment of this application.

### DETAILED DESCRIPTION

The following clearly and completely describes the technical solutions in some embodiments of this application with reference to the accompanying drawings in some embodiments of this application. Apparently, the described embodiments are only some embodiments rather than all embodiments of this application. All other embodiments obtained by persons skilled in the art based on this application shall fall within the protection scope of this application.

It should be noted that in specific embodiments of this application, an example in which a lithium-ion battery is used as a secondary battery is used to illustrate this application. However, the secondary battery of this application is not limited to the lithium-ion battery.

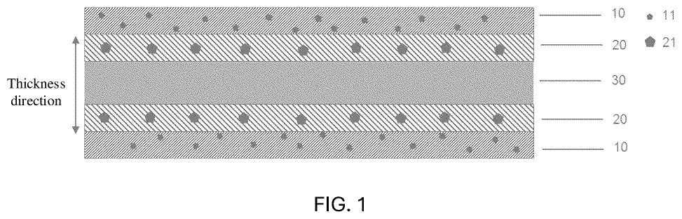

According to a first aspect, this application provides a negative electrode plate. The negative electrode plate includes a negative electrode current collector, as well as a first active substance layer and a second active substance layer disposed on at least one surface of the negative electrode current collector. In a thickness direction of the negative electrode plate, the second active substance layer is disposed between the negative electrode current collector and the first active substance layer; the first active substance layer includes a first active material and a first binder; and the second active substance layer includes a second active material and a second binder. The “disposed on at least one surface of the negative electrode current collector” means that the first active substance layer and the second active substance layer may be disposed on one surface of the negative electrode current collector in its thickness direction or on two surfaces of the negative electrode current collector in its thickness direction. It should be noted that the “surface” herein may be an entire region of the surface of the negative electrode current collector or a partial region of the surface of the negative electrode current collector. This is not particularly limited in this application, provided that the objectives of this application can be achieved. For example, FIG. 1 shows a negative electrode plate according to an embodiment of this application. The negative electrode plate includes a negative electrode current collector 30, a first active substance layer 10, and a second active substance layer 20. The first active substance layer 10 and the second active substance layer 20 are disposed on two surfaces of the negative electrode current collector 30. In a thickness direction of the negative electrode plate, the second active substance layer 20 is disposed between the negative electrode current collector 30 and the first active substance layer 10; the first active substance layer 10 includes a first active material 11 and a first binder (not shown in the FIGURE); and the second active substance layer 20 includes a second active material 21 and a second binder (not shown in the FIGURE).

The first active material includes a first silicon material, and the first binder includes a polyacrylic acid binder. The second active material includes a second silicon material, and the second binder includes a styrene-butadiene rubber binder. A mass percentage of the first silicon material in the first active substance layer is P1, and a mass percentage of the second silicon material in the second active substance layer is P2, where P2<P1. A particle size Dᵥ50 of the first silicon material is D1, and a particle size Dᵥ50 of the second silicon material is D2, where D1<D2. In this application, the first active substance layer and the second active substance layer are disposed on at least one surface of the negative electrode current collector; the first active substance layer farther away from the negative electrode current collector uses a silicon material with higher percentage and smaller particle size and a PAA binder with better adhesion performance, where the silicon material with smaller particle size has a larger specific surface area and more active sites for reaction, improving the ion transport efficiency and improving the kinetic performance of the active material of the first active substance layer; in addition, the PAA binder can form strong hydrogen bonds with the silicon material to provide a large adhesion force, thereby ensuring the stability of the first active substance layer during cycling; the second active substance layer closer to the negative electrode current collector uses a silicon material with lower percentage and larger particle size and an SBR binder with better kinetic performance, enhancing the capability of the second active substance layer participating in lithium ion intercalation and deintercalation, effectively improving lithium ion transport efficiency in a negative electrode of the secondary battery, and also alleviating the problems such as significant swelling of the silicon-containing negative electrode plate, thereby ensuring the cycling stability of the secondary battery while improving the kinetic performance of the secondary battery, and allowing the secondary battery to have both good kinetic performance and cycling stability. In this application, Dᵥ50 indicates a particle size where the cumulative volume reaches 50% as counted from the small particle size side in volume-based particle size distribution.

In an embodiment of this application, 0.1%≤P2<P1≤30%. For example, P1 may be 0.11%, 0.3%, 0.4%, 0.5%, 0.6%, 0.8%, 1%, 1.2%, 1.5%, 2%, 3%, 4%, 5%, 6%, 8%, 10%, 12%, 15%, 17%, 18%, 20%, 22%, 25%, 26%, 27%, 28%, 29%, 30%, or a range defined by any two of these values; P2 may be 0.1%, 0.2%, 0.3%, 0.4%, 0.5%, 0.6%, 0.8%, 1%, 1.2%, 1.5%, 2%, 3%, 4%, 5%, 6%, 8%, 10%, 12%, 15%, 17%, 18%, 20%, 22%, 25%, 26%, 27%, 28%, 29%, 29.9%, or a range defined by any two of these values; and P2<P1. In this application, controlling the percentage of the first silicon material in the first active substance layer to be within the foregoing range can effectively improve the ion transport efficiency, thereby improving the kinetic performance of the secondary battery. In addition, the high-percentage silicon material and the PAA binder are combined for use in the first active substance layer, and the PAA binder can form strong hydrogen bonds with the silicon material to provide a large adhesion force, thereby ensuring the stability of the first active substance layer during cycling. The percentage of the second silicon material in the second active substance layer is controlled to be within the foregoing range, the low-percentage silicon material and the SBR binder are combined for use in the second active substance layer, and the SBR binder has good kinetic performance, improving the kinetic performance of the silicon material in the second active substance layer away from an electrolyte. This ensures the kinetic performance of the secondary battery and the stability of the negative electrode plate during cycling, thereby improving the kinetic performance and cycling stability of the secondary battery.

In an embodiment of this application, 1 μm≤D1<D2≤30 μm. For example, D1 may be 1 μm, 2 μm, 3 μm, 4 μm, 5 μm, 6 μm, 7 μm, 8 μm, 9 μm, 10 μm, 12 μm, 13 μm, 15 μm, 16 μm, 18 μm, 20 μm, 22 μm, 23 μm, 25 μm, 26 μm, 27 μm, 28 μm, 29 μm, 29.9 μm, or a range defined by any two of these values; D2 may be 1.1 μm, 2 μm, 3 μm, 4 μm, 5 μm, 6 μm, 7 μm, 8 μm, 9 μm, 10 μm, 12 μm, 13 μm, 15 μm, 16 μm, 18 μm, 20 μm, 22 μm, 23 μm, 25 μm, 26 μm, 27 μm, 28 μm, 29 μm, 30 μm, or a range defined by any two of these values; and D1<D2. Controlling the particle size Dᵥ50 of the first silicon material in the first active substance layer and the particle size Dᵥ50 of the second silicon material in the second active substance layer to be within the range provided in this application can further improve the ion transport efficiency, thereby improving the kinetic performance of the secondary battery and also ensuring the cycling stability of the secondary battery.

In an embodiment of this application, the first active substance layer further includes a first dispersant. The first dispersant includes a first carboxymethyl cellulose dispersant, and a mass percentage F1 of the first dispersant in the first active substance layer is 0.1% to 5%. For example, F1 may be 0.1%, 0.2%, 0.3%, 0.4%, 0.5%, 0.6%, 0.8%, 1%, 1.2%, 1.5%, 2%, 2.5%, 3%, 3.5%, 4%, 4.5%, 5%, or a range defined by any two of these values. The foregoing type of dispersant with the foregoing percentage is used, and the PAA binder and CMC dispersant are combined for use in the first active substance layer, where the PAA binder has low expansion, high elasticity modulus, and high content of carboxyl, and can form strong hydrogen bonds with the silicon material to provide a large adhesion force and large rigidity, and can be combined with a CMC material having self-recovery hydrogen bonds to improve the stability of the first active substance layer during cycling, thereby improving the kinetic performance of the secondary battery and also ensuring the cycling stability of the secondary battery.

In an embodiment of this application, the second active substance layer further includes a second dispersant. The second dispersant includes a second carboxymethyl cellulose dispersant, and a mass percentage F2 of the second dispersant in the second active substance layer is 0.1% to 5%. For example, F2 may be 0.1%, 0.2%, 0.3%, 0.4%, 0.5%, 0.6%, 0.8%, 1%, 1.2%, 1.5%, 2%, 2.5%, 3%, 3.5%, 4%, 4.5%, 5%, or a range defined by any two of these values. The use of the foregoing type of dispersant with the foregoing percentage and the combined use of the low-percentage silicon material, the SBR binder with good kinetic performance, and the CMC dispersant in the second active substance layer can improve the kinetic performance of the silicon material in the second active substance layer away from the electrolyte, thereby improving the kinetic performance of the secondary battery.

The carboxymethyl cellulose dispersant is not particularly limited in this application, provided that the objectives of this application can be achieved. In some embodiments, the first carboxymethyl cellulose dispersant and the second carboxymethyl cellulose dispersant each independently include at least one of lithium carboxymethyl cellulose or sodium carboxymethyl cellulose.

In an embodiment of this application, the first active substance layer further includes a first dispersant, the first dispersant includes a first carboxymethyl cellulose dispersant, and a mass percentage F1 of the first dispersant in the first active substance layer is 0.1% to 5%; and the second active substance layer further includes a second dispersant, the second dispersant includes a second carboxymethyl cellulose dispersant, and a mass percentage F2 of the second dispersant in the second active substance layer is 0.1% to 5%. The use of both the foregoing types of first dispersant and second dispersant within the foregoing percentage ranges can better exert a synergistic effect of the first active substance layer and the second active substance layer, thereby further improving the kinetic performance and cycling stability of the secondary battery.

In an embodiment of this application, 1 μm≤D1≤8 μm. For example, D1 may be 1 μm, 1.1 μm, 1.2 μm, 1.3 μm, 1.5 μm, 1.6 μm, 1.8 μm, 2 μm, 2.2 μm, 2.5 μm, 2.6 μm, 2.8 μm, 3 μm, 3.2 μm, 3.5 μm, 3.8 μm, 4 μm, 4.2 μm, 4.5 μm, 4.8 μm, 5 μm, 5.1 μm, 5.2 μm, 5.5 μm, 5.8 μm, 6 μm, 6.2 μm, 6.5 μm, 6.8 μm, 7 μm, 7.2 μm, 7.3 μm, 7.5 μm, 7.6 μm, 7.7 μm, 7.8 μm, 8 μm, or a range defined by any two of these values. In this application, the particle size Dᵥ50 of the first silicon material in the first active substance layer is controlled to be within the foregoing range, so that the silicon material with smaller particle size has a larger specific surface area and more active sites for reaction, thereby accelerating ion transport and improving the kinetic performance of the secondary battery. In addition, the combination with the PAA binder with good adhesion performance for use reduces expansion of the silicon material, thereby improving swelling resistance of the silicon-containing negative electrode plate, improving the cycling stability of the secondary battery, and prolonging the cycle life of the secondary battery.

In an embodiment of this application, 8 μm<D2≤30 μm. For example, D2 may be 8.1 μm, 8.2 μm, 8.3 μm, 8.5 μm, 8.6 μm, 8.8 μm, 9 μm, 9.2 μm, 9.3 μm, 9.5 μm, 9.8 μm, 10 μm, 10.5 μm, 11 μm, 11.5 μm, 12 μm, 13 μm, 14 μm, 15 μm, 16 μm, 17 μm, 18 μm, 20 μm, 22 μm, 23 μm, 24 μm, 25 μm, 26 μm, 27 μm, 28 μm, 29 μm, 30 μm, or a range defined by any two of these values. In this application, controlling the particle size Dᵥ50 of the second silicon material in the second active substance layer to be within the foregoing range and using the SBR binder with good kinetic performance can improve the kinetic performance of the second active material, thereby improving the kinetic performance of the secondary battery.

In an embodiment of this application, 1 μm≤D1≤8 μm, and 8 μm<D2≤30 μm. In this application, controlling both the particle size Dᵥ50 of the first silicon material and the particle size Dᵥ50 of the second silicon material to be within the foregoing ranges can better exert a synergistic effect of the first active substance layer and the second active substance layer, thereby further improving the kinetic performance and cycling stability of the secondary battery.

In an embodiment of this application, a ratio of the particle size Dᵥ50 to a particle size Dᵥ90 of the first silicon material is G1, satisfying 0.55<G1<0.7. For example, G1 may be 0.56, 0.57, 0.58, 0.59, 0.6, 0.61, 0.62, 0.63, 0.64, 0.65, 0.66, 0.67, 0.68, 0.69, 0.7, or a range defined by any two of these values. In this application, controlling the particle size Dᵥ50/Dᵥ90 of the first silicon material in the first active substance layer to be within the foregoing range and using the PAA binder with good adhesion performance can better exert the ion transport performance of the silicon material and the adhesion performance of the binder, ensuring both the kinetic performance and swelling resistance of the negative electrode plate, thereby improving the kinetic performance and cycling stability of the secondary battery. In this application, Dᵥ90 indicates a particle size where the cumulative volume reaches 90% as counted from the small particle size side in volume-based particle size distribution. In this application, the Dᵥ50 and Dᵥ90 of the silicon material can be controlled by means known to persons skilled in the art. For example, the Dᵥ50 and Dᵥ90 of the silicon material can be controlled by controlling parameters of classification, shaping, and sieving, thereby controlling a value of G1 or G2. The particle size Dᵥ90 of the first silicon material is not particularly limited in this application, provided that the objectives of this application can be achieved. For example, the particle size Dᵥ90 of the first silicon material may be 1.5 μm to 14.5 μm.

In an embodiment of this application, a ratio of the particle size Dᵥ50 to a particle size Dᵥ90 of the second silicon material is G2, satisfying 0.5≤G2≤0.55. For example, G2 may be 0.5, 0.51, 0.52, 0.53, 0.54, 0.55, or a range defined by any two of these values. In this application, controlling the particle size Dᵥ50/Dᵥ90 of the second silicon material in the second active substance layer to be within the foregoing range and using the SBR binder with good kinetic performance can enhance lithium ion intercalation and deintercalation capability of the second active material and reduce influence on an expansion volume of the second silicon material, thereby improving the kinetic performance and cycling stability of the secondary battery. The particle size Dᵥ90 of the second silicon material is not particularly limited in this application, provided that the objectives of this application can be achieved. For example, the particle size Dᵥ90 of the second silicon material may be 15 μm to 60 μm.

In an embodiment of this application, a ratio of the particle size Dᵥ50 to the particle size Dᵥ90 of the first silicon material is G1, satisfying 0.55<G1≤0.7; and the particle size Dᵥ50 to the particle size Dᵥ90 of the second silicon material is G2, satisfying 0.5≤G2≤0.55. In this application, controlling both the particle size Dᵥ50/Dᵥ90 of the first silicon material and the particle size Dᵥ50/Dᵥ90 of the second silicon material to be within the foregoing ranges can better exert a synergistic effect of the first silicon material and the PAA binder and a synergistic effect of the second silicon material and the SBR binder, thereby further improving the kinetic performance and cycling stability of the secondary battery.

In an embodiment of this application, the first active material further includes first graphite. Based on a total mass of the first active material, a mass percentage A1 of the first silicon material is 1% to less than 100%, and a mass percentage B1 of the first graphite is greater than 0% to 99%. For example, the mass percentage A1 of the first silicon material may be 1%, 2%, 3%, 5%, 6%, 8%, 10%, 12%, 15%, 18%, 20%, 22%, 25%, 28%, 30%, 32%, 35%, 38%, 40%, 42%, 45%, 48%, 50%, 55%, 60%, 65%, 70%, 75%, 80%, 85%, 90%, 92%, 95%, 98%, less than 100%, or a range defined by any two of these values; and the mass percentage B1 of the first graphite may be greater than 0%, 1%, 2%, 3%, 5%, 6%, 8%, 10%, 12%, 15%, 18%, 20%, 22%, 25%, 28%, 30%, 32%, 35%, 38%, 40%, 42%, 45%, 48%, 50%, 55%, 60%, 65%, 70%, 75%, 80%, 85%, 90%, 92%, 95%, 98%, 99%, or a range defined by any two of these values. In an embodiment of this application, the mass percentage A1 of the first silicon material is 15% to less than 100%, and the mass percentage B1 of the first graphite is greater than 0% to 85%. During discharging of the secondary battery, the active material graphite in the active substance layer is discharged first, and the silicon material starts to be discharged only in a final discharging stage. This prolongs an ion transport distance between lithium ions and the silicon material. Therefore, controlling the percentage A1 of the first silicon material and the percentage B1 of the first graphite to be within the foregoing ranges can effectively improve the ion transport efficiency in the final discharging stage, thereby improving the kinetic performance of the secondary battery. In addition, the silicon material increases a cycling swelling rate of the negative electrode plate. In combination with the PAA binder which has low expansion, high elasticity modulus, and high content of carboxyl, and can form strong hydrogen bonds with the silicon material to provide a large adhesion force, the first active substance layer has good stability during cycling, thereby allowing the secondary battery to have both good kinetic performance and cycling stability.

In an embodiment of this application, the second active material further includes second graphite. Based on a total mass of the second active material, a mass percentage A2 of the second silicon material is greater than 0% to 99%, and a mass percentage B2 of the second graphite is 1% to less than 100%. For example, the mass percentage A2 of the second silicon material may be greater than 0%, 1%, 2%, 3%, 5%, 6%, 8%, 10%, 12%, 15%, 18%, 20%, 22%, 25%, 28%, 30%, 32%, 35%, 38%, 40%, 42%, 45%, 48%, 50%, 55%, 60%, 65%, 70%, 75%, 80%, 85%, 90%, 92%, 95%, 98%, 99%, or a range defined by any two of these values; and the mass percentage B2 of the second graphite may be 1%, 2%, 3%, 5%, 6%, 8%, 10%, 12%, 15%, 18%, 20%, 22%, 25%, 28%, 30%, 32%, 35%, 38%, 40%, 42%, 45%, 48%, 50%, 55%, 60%, 65%, 70%, 75%, 80%, 85%, 90%, 92%, 95%, 98%, 99%, less than 100%, or a range defined by any two of these values. In an embodiment of this application, the mass percentage A2 of the second silicon material is 1% to 15%, and the mass percentage B2 of the second graphite is 85% to 99%. In this application, controlling the percentage A2 of the second silicon material and the percentage B2 of the second graphite to be within the foregoing ranges and using the SBR binder with good kinetic performance can improve the kinetic performance of the silicon material in the second active substance layer farther away from the electrolyte, thereby improving the kinetic performance of the secondary battery.

In an embodiment of this application, the first active material further includes first graphite, and based on a total mass of the first active material, a mass percentage A1 of the first silicon material is 1% to less than 100%, and a mass percentage B1 of the first graphite is greater than 0% to 99%; and the second active material further includes second graphite, and based on a total mass of the second active material, a mass percentage A2 of the second silicon material is greater than 0% to 99%, and a mass percentage B2 of the second graphite is 1% to less than 100%. In an embodiment of this application, the mass percentage A1 of the first silicon material is 15% to less than 100%, and the mass percentage B1 of the first graphite is greater than 0% to 85%; and the mass percentage A2 of the second silicon material is 1% to 15%, and the mass percentage B2 of the second graphite is 85% to 99%. During discharging of the secondary battery, the active material graphite in the active substance layer is discharged first, and the silicon material starts to be discharged only in a final discharging stage. This prolongs an ion transport distance between lithium ions and the silicon material. Therefore, controlling the percentage A1 of the first silicon material and the percentage B1 of the first graphite to be within the foregoing ranges can effectively improve the ion transport efficiency in the final discharging stage, thereby improving the kinetic performance of the secondary battery. In addition, the silicon material increases a cycling swelling rate of the negative electrode plate. The first silicon material and the PAA binder are combined for use, where the PAA binder has low expansion, high elasticity modulus, and high content of carboxyl, and can form strong hydrogen bonds with the silicon material to provide a large adhesion force, allowing the first active substance layer to have good stability during cycling. Moreover, in the second active substance layer, controlling the percentage A2 of the second silicon material and the percentage B2 of the second graphite to be within the foregoing ranges and using the SBR binder can improve the kinetic performance of the silicon material in the second active substance layer, thereby exerting a synergistic effect of the first active substance layer and the second active substance layer, and improving the kinetic performance and cycling stability of the secondary battery.

In an embodiment of this application, a mass percentage N1 of the first binder in the first active substance layer is 1% to 10%. For example, N1 may be 1%, 1.2%, 1.5%, 1.8%, 2%, 2.2%, 2.5%, 2.8%, 3%, 3.2%, 3.5%, 3.8%, 4%, 4.2%, 4.5%, 4.8%, 5%, 5.2%, 5.5%, 5.8%, 6%, 6.2%, 6.5%, 6.8%, 7%, 7.2%, 7.5%, 7.8%, 8%, 8.2%, 8.5%, 8.8%, 9%, 9.2%, 9.5%, 9.8%, 10%, or a range defined by any two of these values. Controlling the percentage of the first binder to be within the range provided in this application can better exert a synergistic effect of the first silicon material and the first binder, ensuring both kinetic performance and cycling swelling resistance of the negative electrode plate, thereby allowing the secondary battery to have both good kinetic performance and cycling stability.

In an embodiment of this application, a mass percentage N2 of the second binder in the second active substance layer is 1% to 10%. For example, N2 may be 1%, 1.2%, 1.5%, 1.8%, 2%, 2.2%, 2.5%, 2.8%, 3%, 3.2%, 3.5%, 3.8%, 4%, 4.2%, 4.5%, 4.8%, 5%, 5.2%, 5.5%, 5.8%, 6%, 6.2%, 6.5%, 6.8%, 7%, 7.2%, 7.5%, 7.8%, 8%, 8.2%, 8.5%, 8.8%, 9%, 9.2%, 9.5%, 9.8%, 10%, or a range defined by any two of these values. Controlling the percentage of the second binder to be within the range provided in this application can better exert a synergistic effect of the second silicon material and the second binder, further improving the kinetic performance of the negative electrode plate, thereby further improving the kinetic performance of the secondary battery.

In an embodiment of this application, the mass percentage N1 of the first binder in the first active substance layer is 1% to 10%; and the mass percentage N2 of the second binder in the second active substance layer is 1% to 10%. In this application, controlling the percentages of the first binder and the second binder to be within the foregoing ranges can further exert the synergistic effect of the first active substance layer and the second active substance layer, thereby further improving the kinetic performance and cycling stability of the secondary battery.

In an embodiment of this application, the first active substance layer further includes a first conductive agent, and a mass percentage C1 of the first conductive agent in the first active substance layer is 0.1% to 5%. For example, C1 may be 0.1%, 0.2%, 0.3%, 0.4%, 0.5%, 0.6%, 0.8%, 1%, 1.2%, 1.5%, 2%, 2.5%, 3%, 3.5%, 4%, 4.5%, 5%, or a range defined by any two of these values. In this application, controlling the percentage of the first conductive agent to be within the foregoing range can improve the kinetic performance of the first active substance layer, thereby improving the kinetic performance of the secondary battery.

In an embodiment of this application, the second active substance layer further includes a second conductive agent, and a mass percentage C2 of the second conductive agent in the second active substance layer is 0.1% to 5%. For example, C2 may be 0.1%, 0.2%, 0.3%, 0.4%, 0.5%, 0.6%, 0.8%, 1%, 1.2%, 1.5%, 2%, 2.5%, 3%, 3.5%, 4%, 4.5%, 5%, or a range defined by any two of these values. In this application, controlling the percentage of the second conductive agent to be within the foregoing range can improve the kinetic performance of the second active substance layer, thereby improving the kinetic performance of the secondary battery.

In an embodiment of this application, the first active substance layer further includes a first conductive agent, and a mass percentage C1 of the first conductive agent in the first active substance layer is 0.1% to 5%; and the second active substance layer further includes a second conductive agent, and a mass percentage C2 of the second conductive agent in the second active substance layer is 0.1% to 5%. In this application, controlling both the percentages of the first conductive agent and the second conductive agent to be within the foregoing ranges can further exert the synergistic effect of the first active substance layer and the second active substance layer, thereby further improving the kinetic performance of the secondary battery.

In an embodiment of this application, the polyacrylic acid binder includes at least one of polyacrylic acid or polymethacrylic acid. A weight-average molecular weight Mw of polyacrylic acid or polymethacrylic acid is not particularly limited in this application, provided that the objectives of this application can be achieved. For example, the Mw of polyacrylic acid is 3000 to 4000000, and the Mw of polymethacrylic acid is 5000 to 100000. Using the foregoing PAA binder in the first active substance layer helps to exert a synergistic effect of the first silicon material and the PAA binder, improving the kinetic performance and cycling swelling resistance of the first silicon material, thereby helping to improve the kinetic performance and cycling stability of the secondary battery.

In an embodiment of this application, the styrene-butadiene rubber binder includes at least one of styrene-butadiene rubber emulsion, styrene-acrylate emulsion, or pure acrylate emulsion. In this application, the styrene-acrylate emulsion (styrene-acrylate emulsion) is obtained by emulsion copolymerization of styrene and an acrylate monomer, where a molar ratio of styrene to an acrylate monomer is 1 to 4. Model numbers of the above emulsions are not particularly limited in this application, provided that the objectives of this application can be achieved. Emulsions of different model numbers may be purchased from markets. Solid contents of the above emulsions are not particularly limited in this application, provided that the objectives of this application can be achieved. For example, the solid contents of the emulsions are 20 wt % to 50 wt %. Using the foregoing SBR binder in the second active substance layer helps to exert a synergistic effect of the second silicon material and the SBR binder, improving the kinetic performance of the second silicon material, thereby helping to improve the kinetic performance of the secondary battery.

The silicon material is not particularly limited in this application, provided that the purposes of this application can be achieved. In an embodiment of this application, the first silicon material and the second silicon material each independently include at least one of pure silicon, a silicon alloy material, a silicon-carbon composite material, or a silicon oxide. In this application, the pure silicon, for example, may include but is not limited to at least one of silicon nanoparticles, silicon nanowires, or micron silicon. The silicon alloy material, for example, may include but is not limited to at least one of silicon-tin alloy, silicon-magnesium alloy, silicon-iron alloy, silicon-aluminum alloy, silicon-nickel alloy, or silicon-iron-aluminum alloy. The silicon-carbon composite material refers to a material formed by compounding silicon and carbon, such as SiC. The silicon oxide includes a material represented by SiOx, where x is 0 to 2. In this application, the use of the foregoing types of silicon materials helps to exert a synergistic effect of the silicon material and the PAA binder and a synergistic effect of the silicon material and the SBR binder and helps to improve the kinetic performance and cycling swelling resistance of the negative electrode plate, thereby helping to improve the kinetic performance and cycling stability of the secondary battery.

The mass percentage of the first active material in the first active substance layer is not particularly limited in this application, provided that the objectives of this application can be achieved. In some embodiments, the mass percentage of the first active material in the first active substance layer is 80% to 98%. The mass percentage S1 of the first graphite in the first active substance layer is not particularly limited in this application, provided that the objectives of this application can be achieved. The mass percentage of the second active material in the second active substance layer is not particularly limited in this application, provided that the objectives of this application can be achieved. In some embodiments, the mass percentage of the second active material in the second active substance layer is 80% to 98%. The mass percentage S2 of the second graphite in the second active substance layer is not particularly limited in this application, provided that the objectives of this application can be achieved.

The types of the first conductive agent and the second conductive agent are not particularly limited in this application, provided that the objectives of this application can be achieved. For example, the first conductive agent and the second conductive agent each independently include but are not limited to at least one of a carbon-based material, a metal-based material, or a conductive polymer. For example, the carbon-based material may include at least one of natural graphite, artificial graphite, acetylene black, Ketjen black, or carbon fiber; the metal-based material may include but is not limited to at least one of metal powder, metal fiber, copper, nickel, aluminum, or silver; and the conductive polymer may include but is not limited to a polyphenylene derivative.

The negative electrode current collector is not particularly limited in this application, provided that the objectives of this application can be achieved. For example, the negative electrode current collector may include copper foil, aluminum foil, copper alloy foil, nickel foil, stainless steel foil, titanium foil, nickel foam, copper foam, or the like. The thicknesses of the negative electrode current collector, first active substance layer, and second active substance layer are not particularly limited in this application, provided that the objectives of this application can be achieved. For example, the thickness of the negative electrode current collector is 4 μm to 12 μm; the thickness of a single-sided first active substance layer is 30 μm to 130 μm; and the thickness of a single-sided second active substance layer is 30 μm to 130 μm. The thickness of the negative electrode plate is not particularly limited in this application, provided that the objectives of this application can be achieved. For example, the thickness of the negative electrode plate is 50 μm to 280 μm.

According to a second aspect, this application provides a secondary battery including the negative electrode plate according to any one of the foregoing embodiments. The secondary battery according to the second aspect of this application has good kinetic performance and cycling stability.

The secondary battery in this application further includes a positive electrode plate. The positive electrode plate is not particularly limited in this application, provided that the objectives of this application can be achieved. For example, the positive electrode plate includes a positive electrode current collector and a positive electrode active material layer disposed on at least one surface of the positive electrode current collector. In this application, the positive electrode active material layer may be disposed on one surface of the positive electrode current collector in its thickness direction, or may be disposed on two surfaces of the positive electrode current collector in its thickness direction. It should be noted that the “surface” herein may be an entire region of the positive electrode current collector, or may be a partial region of the positive electrode current collector. This is not particularly limited in this application, provided that the objectives of this application can be achieved.

The positive electrode current collector is not particularly limited in this application, provided that the objectives of this application can be achieved. For example, the positive electrode current collector may include but is not limited to an aluminum foil, an aluminum alloy foil, or a composite current collector (for example, an aluminum-carbon composite current collector). The thicknesses of the positive electrode current collector and the positive electrode active material layer are not particularly limited in this application, provided that the objectives of this application can be achieved. For example, the thickness of the positive electrode current collector is 6 μm to 12 μm, and the thickness of the positive electrode active material layer is 30 μm to 120 μm. The thickness of the positive electrode plate is not particularly limited in this application, provided that the objectives of this application can be achieved. For example, the thickness of the positive electrode plate is 50 μm to 250 μm.

The positive electrode active material layer of this application includes a positive electrode active material, and the positive electrode active material includes a substance that can reversibly intercalate and deintercalate active ions such as lithium ions. One or a plurality of positive electrode active material layers may be provided, and each of the plurality of positive electrode active material layers may include the same or different positive electrode active materials. The positive electrode active material is not particularly limited in this application, provided that the objectives of this application can be achieved. For example, the positive electrode active material may include but is not limited to at least one of lithium nickel cobalt manganate (for example, NCM811, NCM622, NCM523, and NCM111), lithium nickel cobalt aluminate, lithium iron phosphate, a lithium-rich manganese-based material, lithium cobaltate (LiCoO₂), lithium manganate, lithium ferromanganese phosphate, or lithium titanate.

The positive electrode active material layer may further include a conductive agent and a binder. Types of the conductive agent and the binder are not particularly limited in this application, provided that the objectives of this application can be achieved. For example, the binder may include but is not limited to at least one of polyvinyl alcohol, hydroxypropyl cellulose, diacetyl cellulose, polyvinyl chloride, carboxylated polyvinyl chloride, polyvinyl fluoride, ethylene oxide-containing polymer, polyvinylpyrrolidone, polyurethane, polytetrafluoroethylene, polyvinylidene fluoride, polyethylene, polypropylene, styrene-butadiene rubber, acrylic (acrylated) styrene-butadiene rubber, epoxy resin, or nylon; and the conductive agent may include but is not limited to a carbon-based material, a metal-based material, or a conductive polymer. For example, the carbon-based material may include at least one of natural graphite, artificial graphite, acetylene black, Ketjen black, or carbon fiber; the metal-based material may include but is not limited to at least one of metal powder, metal fiber, copper, nickel, aluminum, or silver; and the conductive polymer may include but is not limited to a polyphenylene derivative. A mass ratio of the positive electrode active material, the conductive agent, and the binder in the positive electrode active material layer is not particularly limited in this application and can be selected based on actual needs, provided that the objectives of this application can be achieved.

In this application, the secondary battery further includes a separator configured to separate the positive electrode plate from the negative electrode plate, to prevent short circuits inside the secondary battery and to allow electrolyte ions to pass through freely without affecting electrochemical charging and discharging processes. The separator is not particularly limited in this application, provided that the objectives of this application can be achieved. For example, the separator may be made of a material including but not limited to at least one of polyethylene (PE) and polypropylene (PP)-based polyolefin (PO), polyester (for example, polyethylene terephthalate (PET) film), cellulose, polyimide (PI), polyamide (PA), spandex, or aramid. A type of the separator may include at least one of woven film, non-woven film, microporous film, composite film, laminated film, or spun film. For example, the separator may include a substrate layer and a surface treatment layer. The substrate layer may be a non-woven fabric, film, or composite film having a porous structure, and the substrate layer may be made of a material including at least one of polyethylene, polypropylene, polyethylene glycol terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used. Optionally, the surface treatment layer is provided on at least one surface of the substrate layer, and the surface treatment layer may be a polymer layer, an inorganic substance layer, or a layer formed by mixing a polymer and an inorganic substance. For example, the inorganic substance layer includes inorganic particles and a binder. The inorganic particles are not particularly limited in this application. For example, the inorganic substance layer may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited in this application. For example, the binder can be at least one of the foregoing binders. The polymer layer includes a polymer, and the polymer is made of a material including at least one of polyamide, polyacrylonitrile, acrylate polymer, polyacrylic acid, polyacrylic salt, polyvinylpyrrolidone, polyvinyl ether, polyvinylidene fluoride, or poly (vinylidene fluoride-hexafluoropropylene). The thickness of the separator is not particularly limited in this application, provided that the objectives of this application can be achieved. For example, the thickness of the separator may be 5 μm to 500 μm.

In this application, the secondary battery further includes an electrolyte. In some embodiments, the electrolyte includes a lithium salt. A type of the lithium salt is not particularly limited in this application, and any lithium salt known in the art can be used. For example, the lithium salt may include but is not limited to at least one of lithium hexafluorophosphate (LiPF₆), lithium bis(trifluoromethanesulfonyl)imide (LiN(CF₃SO₂)₂, LiTFSI), lithium bis(fluorosulfonyl)imide (Li(N(SO₂F)₂), LiFSI), lithium difluorophosphate (LiPO₂F₂), lithium bis(oxalato)borate (LiB(C₂O₄)₂, LiBOB), or lithium difluoro(oxalato)borate (LiBF₂(C₂O₄), LiDFOB). A percentage of the lithium salt in the electrolyte is not particularly limited in this application, provided that the objectives of this application can be achieved.

In some embodiments, the electrolyte includes a non-aqueous organic solvent. The non-aqueous organic solvent is not particularly limited in this application, provided that the objectives of this application can be achieved. For example, the non-aqueous organic solvent may include at least one of a carbonate compound, a carboxylate compound, an ether compound, or another organic solvent. The carbonate compound may include but is not limited to at least one of a linear carbonate compound, a cyclic carbonate compound, or a fluorocarbonate compound. The linear carbonate compound may include but is not limited to at least one of dimethyl carbonate (DMC), diethyl carbonate (DEC), dipropyl carbonate (DPC), methyl propyl carbonate (MPC), ethylene propyl carbonate (EPC), or methyl ethyl carbonate (EMC). The cyclic carbonate compound may include but is not limited to at least one of ethylene carbonate (EC), propylene carbonate (PC), butylene carbonate (BC), or vinyl ethylene carbonate (VEC). The fluorocarbonate compound may include but is not limited to at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1, 1,2-trifluoro-2-methylethylene carbonate, or trifluoromethylethylene carbonate. The carboxylate compound may include but is not limited to at least one of methyl formate, methyl acetate, ethyl acetate, n-propyl acetate, tert-butyl acetate, methyl propionate, ethyl propionate, or propyl propionate. The ether compound may include but is not limited to at least one of dibutyl ether, tetraglyme, diglyme, 1,2-dimethoxyethane, 1,2-diethoxyethane, ethoxymethoxy ethane, 2-methyltetrahydrofuran, or tetrahydrofuran. The another organic solvent may include but is not limited to at least one of dimethyl sulfoxide, 1,2-dioxolane, sulfolane, methyl-sulfolane, 1,3-dimethyl-2-imidazolidinone, N-methyl-2-pyrrolidone, methylamide, dimethylformamide, acetonitrile, trimethyl phosphate, triethyl phosphate, trioctyl phosphate, or phosphate ester.

In some embodiments, the secondary battery further includes a housing for accommodating the positive electrode plate, the separator, the negative electrode plate, and the electrolyte, as well as other components known in the field of secondary batteries. The other components are not limited in this application. The housing is not particularly limited in this application, and may be any housing well known in the art, provided that the objectives of this application can be achieved. For example, the housing may be a hard housing or a flexible housing. The hard housing may be made of a metal material, and a type of metal is not limited in this application. Any metal hard housing known in the art may be used, provided that the objectives of this application can be achieved. The flexible housing may be a metal plastic film, such as an aluminum plastic film or a steel plastic film.

A type of the secondary battery is not particularly limited in this application, and the secondary battery may include any apparatus that undergoes electrochemical reactions. For example, the secondary battery may include but is not limited to a lithium metal secondary battery, a lithium-ion secondary battery (lithium-ion battery), a sodium-ion secondary battery (sodium-ion battery), a lithium polymer secondary battery, and a lithium-ion polymer secondary battery (lithium-ion polymer battery).

A preparation process of the secondary battery of this application is well known to persons skilled in the art, and is not particularly limited in this application. For example, the preparation process may include but is not limited to the following steps: a positive electrode plate, a separator, and a negative electrode plate are stacked in sequence and subjected to operations such as winding and folding as needed to obtain an electrode assembly of a wound structure, the electrode assembly is put into a housing, an electrolyte is injected into the housing, and the housing is sealed to obtain a secondary battery; alternatively, a positive electrode plate, a separator, and a negative electrode plate are stacked in sequence, four corners of the entire stacked structure are fixed with tapes to obtain an electrode assembly of a stacked structure, the electrode assembly is put into a housing, an electrolyte is injected into the housing, and the housing is sealed to obtain a secondary battery. In addition, an over-current protection element, a guide plate, and the like may also be placed into the housing as needed, to prevent pressure rise, overcharge, and overdischarge inside the secondary battery.

According to a third aspect, this application provides an electronic apparatus including the secondary battery according to any one of the foregoing embodiments. The electronic apparatus of this application is not particularly limited, and may be any electronic apparatus known in the prior art. In some embodiments, the electronic apparatus may include but is not limited to a notebook computer, a pen-input computer, a mobile computer, an e-book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household battery, and a lithium-ion capacitor.

### EXAMPLES

The following provides examples and comparative examples to describe some embodiments of this application more specifically. Various tests and evaluations are performed according to the following methods. In addition, unless otherwise specified, “part” and “%” are based on weight.

### Test Methods and Devices

### Particle Size Test

0.02 g of sample powder of a negative electrode active material was added into a 50 ml clean beaker, and 20 ml of deionized water was added into the breaker, with a surfactant dropwise added to make the powder completely dispersed in the water. Then, the powder was subjected to ultrasonic treatment for 5 min in a 120 W ultrasonic cleaning machine, and a particle size distribution was tested with a laser particle size tester (MasterSizer 2000). Dᵥ50 is a particle size where the cumulative distribution by volume of a material reaches 50% as counted from the small particle size side, and Dᵥ90 is a particle size where the cumulative distribution by volume of the material reaches 90% as counted from the small particle size side.

### Test for Maximum Discharge Temperature at 4 C

A lithium-ion battery was wrapped with thermal insulation cotton; a temperature sensing wire was attached to a center position of an intersection of diagonal lines on the surface of the lithium-ion battery; and a multi-channel thermometer was used to continuously monitor a surface discharge temperature of the lithium-ion battery. In an environment of 25° C., the lithium-ion battery was charged to 4.3 V at a constant current of 1.5 C, and the charging was ended until the lithium-ion battery was charged to a current of 0.05 C at a constant voltage of 4.3 V; the lithium-ion battery was left standing for 15 min, then discharged to 2.5 V at a constant current of 4 C, and left standing for 30 min; and a maximum discharge temperature at 4 C was read from the multi-channel thermometer.

### Cycling Performance Test

In an environment at 25° C., the lithium-ion battery was charged to 4.3 V at a constant current of 1.5 C, and the charging was ended until the lithium-ion battery was charged to a current below 0.05 C at a constant voltage of 4.3 V to make the lithium-ion battery be fully charged; and the lithium-ion battery was left standing for 15 min, then discharged to 2.5 V at a constant current of 4 C, and left standing for 30 min. This procedure was one cycle, 400 cycles were performed for test, a discharge capacity at the 3rd cycle was Q₀, a discharge capacity at the 400th cycle was denoted as Q_{N}, and a cycling capacity retention rate of the lithium-ion battery was equal to Q_{N}/Q₀×100%. A thickness of the lithium-ion battery discharged to 30% SOC state (that was, below 3.6 V) at the first cycle was denoted as To (measured using a PPG battery thickness gauge, with a measurement pressure of 50 g); a thickness of the fully charged lithium-ion battery at the 400th cycle was denoted as T_{N}; and a cycling swelling rate of the lithium-ion battery was equal to (T_{N}−T₀)/T₀×100%.

### Lithium Precipitation Test

At 5° C., the lithium-ion battery was constant-current charged to 4.30 V at a specific charging rate X, then charged to 0.05 C at a constant voltage of 4.30 V, and left standing for 5 min. Then, the lithium-ion battery was discharged to 2.0 V at a constant current of 0.5 C and left standing for 5 min. This was one cycle. After ten cycles were performed, the lithium-ion battery fully charged to 4.30 V at the charging rate X was disassembled; an obtained negative electrode plate was observed; if lithium precipitation occurred in any region that was ≥2 mm² in the negative electrode plate, it was determined that the negative electrode plate had lithium precipitation; and in a case of no lithium precipitation, a maximum charging rate was defined as a maximum no-lithium-precipitation rate of the lithium-ion battery, that was, a lithium precipitation level; where X might be 1 C, 1.5 C, 2 C, or the like, which increased by 0.5 C each time.

### Example 1-1

### <Preparation of Negative Electrode Plate>

A first active material including a first silicon material pure silicon (Dᵥ50 was 5.1 μm, and Dᵥ50/Dᵥ90 was 0.58) and first graphite artificial graphite, a first binder polyacrylic acid (PAA, with a weight-average molecular weight Mw of 4000), a first conductive agent acetylene black, and a first dispersant lithium carboxymethyl cellulose at a mass ratio of 30:66:3:0.5:0.5 were dissolved in deionized water, and fully stirred to uniformity to obtain a first active slurry with a solid content of 75 wt %.

A second active material including a second silicon material pure silicon (Dᵥ50 was 9.3 μm, and Dᵥ50/Dᵥ90 was 0.50) and second graphite artificial graphite, a second binder styrene-butadiene rubber emulsion (SBR of a model number of LB-S420, with a solid content of 46 wt %), a second conductive agent acetylene black, and a second dispersant lithium carboxymethyl cellulose at a mass ratio of 5:91:2.8:0.5:0.7 were dissolved in deionized water, and fully stirred to uniformity to obtain a second active slurry with a solid content of 75 wt %.

A surface of a negative electrode current collector copper foil with a thickness of 6 μm was coated with both the prepared first active slurry and second active slurry using a coating machine with a double layer coating die at a speed of 15 m/min; the second active slurry was in contact with the copper foil to form a second active substance layer, and the first active slurry was in contact with the second active slurry to form a first active substance layer, where surface densities of the first active substance layer and the second active substance layer were both 3.76 mg/cm²; and drying was performed at 80° C. to obtain a negative electrode plate with one surface coated with the first active substance layer and the second active substance layer. Subsequently, the foregoing steps were repeated on the other surface of the copper foil to obtain a negative electrode plate with both surfaces coated with the first active substance layer and the second active substance layer. Then, cold pressing, cutting, and tab welding were performed to obtain a negative electrode plate with a size of 76 mm×867 mm for later use. On each surface, a thickness of the first active substance layer was 30 μm, and a thickness of the second active substance layer was 30 μm.

### [Preparation of Positive Electrode Plate]

A positive electrode active material lithium nickel cobalt manganate (with a molecular formula of LiNi_{0.5}Co_{0.2}Mn_{0.3}O₂, NCM523 for short), a positive electrode conductive agent acetylene black, and a positive electrode binder polyvinylidene fluoride (PVDF) were mixed at a mass ratio of 94:3:3, and added with N-methylpyrrolidone (NMP) as a solvent to prepare a positive electrode slurry with a solid content of 75 wt %. The positive electrode slurry was uniformly applied onto a surface of a positive electrode current collector aluminum foil with a thickness of 6 μm, with a coating weight of 0.13 g/cm²; and the aluminum foil was dried at 90° C. to obtain a positive electrode plate with one surface coated with a positive electrode active material layer. The foregoing steps were repeated on the other surface of the aluminum foil to obtain a positive electrode plate with both surfaces coated with the positive electrode active material layer. Then, cold pressing, cutting, and tab welding were performed to obtain a positive electrode plate with a size of 74 mm×851 mm for later use, where a compacted density of the positive electrode plate was 3.45 g/cm³.

### <Preparation of Electrolyte>

In an argon atmosphere glove box with a moisture content of less than 10 ppm, non-aqueous organic solvents ethylene carbonate (EC), propylene carbonate (PC), diethyl carbonate (DEC), and ethyl methyl carbonate (EMC) were mixed at a weight ratio of 20:30:40:10, and then a lithium salt lithium hexafluorophosphate (LiPF₆) was added into the non-aqueous organic solvents, dissolved and mixed to uniformity to obtain an electrolyte, where a mass percentage of the LiPF₆ in the electrolyte was 12.5%.

### <Preparation of Separator>

A polyethylene (PE) porous film with a thickness of 7 μm (provided by Celgard) was used as the separator.

### <Preparation of Lithium-Ion Battery>

The positive electrode plate, the separator, and the negative electrode plate were stacked in sequence, so that the separator was located between the positive electrode plate and the negative electrode plate for separation, and the stack was wound to obtain an electrode assembly. The electrode assembly was placed in a packaging bag aluminum plastic film; after moisture was removed at 80° C., the above electrolyte was injected; and packaging was performed, followed by processes such as formation, degassing, and trimming, to obtain a lithium-ion battery. An upper voltage limit for the formation was 4.15 V, a temperature for the formation was 70° C., and a standing time for the formation was 2 h.

### Example 1-2 to Example 1-16

These examples were the same as Example 1-1 except that in <Preparation of negative electrode plate>, related preparation parameters were adjusted according to Table 1, a total content of the first silicon material and the first graphite was unchanged, and a total content of the second silicon material and the second graphite was unchanged.

### Example 2-1 to Example 2-18

These examples were the same as Example 1-1 except that in <Preparation of negative electrode plate>, the related preparation parameters were adjusted according to Table 1.

### Comparative Examples 1-1 to 1-3

These comparative examples were the same as Example 1-1 except that in <Preparation of negative electrode plate>, the related preparation parameters were adjusted according to Table 1.

### Comparative Examples 1-4 and 1-5

These comparative examples were the same as Example 1-1 except that in <Preparation of negative electrode plate>, only the first active substance layer or the second active substance layer was applied according to Table 1.

### Comparative Example 1-6

This comparative example was the same as Example 1-13 except that in <Preparation of negative electrode plate>, only the first active substance layer was applied according to Table 1.

### Comparative Example 1-7

This comparative example was the same as Example 1-12 except that in <Preparation of negative electrode plate>, only the second active substance layer was applied according to Table 1.

Preparation parameters and performance tests of the examples and comparative examples are shown in Table 1 and Table 2.

TABLE 1

| | First active substance layer | | | | | | | | | |
|---|---|---|---|---|---|---|---|---|---|---|
| | | | First silicon material | | | | | | Second active substance layer | |
| | S1 | B1 | | P1 | A1 | D1 | | Type of | S2 | B2 |
| | (%) | (%) | Type | (%) | (%) | (μm) | G1 | first binder | (%) | (%) |
| Example | 66 | 68.8 | Pure | 30 | 31.2 | 5.1 | 0.58 | Polyacrylic | 91 | 94.8 |
| 1-1 | | | silicon | | | | | acid | | |
| Example | 66 | 68.8 | Pure | 30 | 31.2 | 5.1 | 0.58 | Polyacrylic | 91 | 94.8 |
| 1-2 | | | silicon | | | | | acid | | |
| Example | 66 | 68.8 | Pure | 30 | 31.2 | 5.1 | 0.58 | Polyacrylic | 91 | 94.8 |
| 1-3 | | | silicon | | | | | acid | | |
| Example | 66 | 68.8 | Pure | 30 | 31.2 | 1 | 0.56 | Polyacrylic | 91 | 94.8 |
| 1-4 | | | silicon | | | | | acid | | |
| Example | 66 | 68.8 | Pure | 30 | 31.2 | 8 | 0.70 | Polyacrylic | 91 | 94.8 |
| 1-5 | | | silicon | | | | | acid | | |
| Example | 76 | 79.2 | Pure | 20 | 20.8 | 5.1 | 0.58 | Polyacrylic | 91 | 94.8 |
| 1-6 | | | silicon | | | | | acid | | |
| Example | 86 | 89.6 | Pure | 10 | 10.4 | 5.1 | 0.58 | Polyacrylic | 91 | 94.8 |
| 1-7 | | | silicon | | | | | acid | | |
| Example | 66 | 68.8 | Pure | 30 | 31.2 | 5.1 | 0.58 | Polyacrylic | 95.9 | 99.9 |
| 1-8 | | | silicon | | | | | acid | | |
| Example | 66 | 68.8 | Pure | 30 | 31.2 | 5.1 | 0.58 | Polyacrylic | 95 | 99 |
| 1-9 | | | silicon | | | | | acid | | |
| Example | 66 | 68.8 | Pure | 30 | 31.2 | 5.1 | 0.58 | Polyacrylic | 81.6 | 85 |
| 1-10 | | | silicon | | | | | acid | | |
| Example | 66 | 68.8 | Pure | 30 | 31.2 | 5.1 | 0.58 | Polyacrylic | 71 | 74 |
| 1-11 | | | silicon | | | | | acid | | |
| Example | 66 | 68.8 | Pure | 30 | 31.2 | 5.1 | 0.58 | Polyacrylic | 78.5 | 81.8 |
| 1-12 | | | silicon | | | | | acid | | |
| Example | 78.5 | 81.8 | Pure | 17.5 | 18.2 | 7.2 | 0.54 | Polyacrylic | 91 | 94.8 |
| 1-13 | | | silicon | | | | | acid | | |
| Example | 38.4 | 40 | Pure | 57.6 | 60 | 5.1 | 0.58 | Polyacrylic | 91 | 94.8 |
| 1-14 | | | silicon | | | | | acid | | |
| Example | 0 | 0 | Pure | 96 | 100 | 5.1 | 0.58 | Polyacrylic | 91 | 94.8 |
| 1-15 | | | silicon | | | | | acid | | |
| Example | 66 | 68.8 | Silicon | 30 | 31.2 | 5.1 | 0.58 | Poly- | 91 | 94.8 |
| 1-16 | | | oxide | | | | | methacrylic | | |
| | | | | | | | | acid | | |
| | | | | | | | | (Mw: 65000) | | |
| Compar- | 66 | 68.8 | Pure | 30 | 31.2 | 9.3 | 0.50 | Polyacrylic | 91 | 94.8 |
| ative | | | silicon | | | | | acid | | |
| Example | | | | | | | | | | |
| 1-1 | | | | | | | | | | |
| Compar- | 66 | 68.8 | Pure | 30 | 31.2 | 5.1 | 0.58 | Styrene- | 91 | 94.8 |
| ative | | | silicon | | | | | butadiene | | |
| Example | | | | | | | | rubber | | |
| 1-2 | | | | | | | | emulsion | | |
| Compar- | 91 | 94.8 | Pure | 5 | 5.2 | 5.1 | 0.58 | Polyacrylic | 66 | 68.8 |
| ative | | | silicon | | | | | acid | | |
| Example | | | | | | | | | | |
| 1-3 | | | | | | | | | | |
| Compar- | 66 | 68.8 | Pure | 30 | 31.2 | 5.1 | 0.58 | Polyacrylic | / | / |
| ative | | | silicon | | | | | acid | | |
| Example | | | | | | | | | | |
| 1-4 | | | | | | | | | | |
| Compar- | / | | / | / | / | / | / | / | 91 | 94.8 |
| ative | | | | | | | | | | |
| Example | | | | | | | | | | |
| 1-5 | | | | | | | | | | |
| Compar- | 78.5 | 81.8 | Pure | 17.5 | 18.2 | 7.2 | 0.54 | Polyacrylic | / | / |
| ative | | | silicon | | | | | acid | | |
| Example | | | | | | | | | | |
| 1-6 | | | | | | | | | | |
| Compar- | / | | / | / | / | / | / | / | 78.5 | 81.8 |
| ative | | | | | | | | | | |
| Example | | | | | | | | | | |
| 1-7 | | | | | | | | | | |

| | | | | | | | Maximum | | | | |
|---|---|---|---|---|---|---|---|---|---|---|---|
| | | | | | | | discharge | | | Cycling | |
| | Second active substance layer | | | | | | temper- | Lithium | | capacity | Cycling |
| | Second silicon material | | | | | Type of | ature | precip- | | retention | swelling |
| | | P2 | A2 | D2 | | second | at 4 C | itation | | rate | rate |
| | Type | (%) | (%) | (μm) | G2 | binder | (° C.) | level | | (%) | (%) |
| Example | Pure | 5 | 5.2 | 9.3 | 0.50 | Styrene- | 60 | 2 | C | 80 | 10 |
| 1-1 | silicon | | | | | butadiene | | | | | |
| | | | | | | rubber | | | | | |
| | | | | | | emulsion | | | | | |
| Example | Pure | 5 | 5.2 | 15 | 0.55 | Styrene- | 60.5 | 2 | C | 79 | 10 |
| 1-2 | silicon | | | | | butadiene | | | | | |
| | | | | | | rubber | | | | | |
| | | | | | | emulsion | | | | | |
| Example | Pure | 5 | 5.2 | 25 | 0.55 | Styrene- | 62 | 1.5 | C | 78 | 11 |
| 1-3 | silicon | | | | | butadiene | | | | | |
| | | | | | | rubber | | | | | |
| | | | | | | emulsion | | | | | |
| Example | Pure | 5 | 5.2 | 9.3 | 0.50 | Styrene- | 58 | 2.5 | C | 81 | 9 |
| 1-4 | silicon | | | | | butadiene | | | | | |
| | | | | | | rubber | | | | | |
| | | | | | | emulsion | | | | | |
| Example | Pure | 5 | 5.2 | 9.3 | 0.50 | Styrene- | 61 | 1.5 | C | 78 | 11 |
| 1-5 | silicon | | | | | butadiene | | | | | |
| | | | | | | rubber | | | | | |
| | | | | | | emulsion | | | | | |
| Example | Pure | 5 | 5.2 | 9.3 | 0.50 | Styrene- | 57.5 | 2.5 | C | 81 | 9 |
| 1-6 | silicon | | | | | butadiene | | | | | |
| | | | | | | rubber | | | | | |
| | | | | | | emulsion | | | | | |
| Example | Pure | 5 | 5.2 | 9.3 | 0.50 | Styrene- | 56.5 | 3 | C | 82 | 8 |
| 1-7 | silicon | | | | | butadiene | | | | | |
| | | | | | | rubber | | | | | |
| | | | | | | emulsion | | | | | |
| Example | Pure | 0.1 | 0.1 | 9.3 | 0.50 | Styrene- | 59.5 | 2 | C | 80 | 9 |
| 1-8 | silicon | | | | | butadiene | | | | | |
| | | | | | | rubber | | | | | |
| | | | | | | emulsion | | | | | |
| Example | Pure | 1 | 1 | 9.3 | 0.50 | Styrene- | 59.5 | 2 | C | 80 | 9 |
| 1-9 | silicon | | | | | butadiene | | | | | |
| | | | | | | rubber | | | | | |
| | | | | | | emulsion | | | | | |
| Example | Pure | 14.4 | 15 | 9.3 | 0.50 | Styrene- | 60 | 2.5 | C | 81 | 10 |
| 1-10 | silicon | | | | | butadiene | | | | | |
| | | | | | | rubber | | | | | |
| | | | | | | emulsion | | | | | |
| Example | Pure | 25 | 26 | 9.3 | 0.50 | Styrene- | 61.5 | 1.5 | C | 78 | 11 |
| 1-11 | silicon | | | | | butadiene | | | | | |
| | | | | | | rubber | | | | | |
| | | | | | | emulsion | | | | | |
| Example | Pure | 17.5 | 18.2 | 7.2 | 0.54 | Styrene- | 62 | 1.5 | C | 78 | 12 |
| 1-12 | silicon | | | | | butadiene | | | | | |
| | | | | | | rubber | | | | | |
| | | | | | | emulsion | | | | | |
| Example | Pure | 5 | 5.2 | 9.3 | 0.50 | Styrene- | 58 | 2.5 | C | 81 | 9 |
| 1-13 | silicon | | | | | butadiene | | | | | |
| | | | | | | rubber | | | | | |
| | | | | | | emulsion | | | | | |
| Example | Pure | 5 | 5.2 | 9.3 | 0.50 | Styrene- | 62 | 2 | C | 79 | 11 |
| 1-14 | silicon | | | | | butadiene | | | | | |
| | | | | | | rubber | | | | | |
| | | | | | | emulsion | | | | | |
| Example | Pure | 5 | 5.2 | 9.3 | 0.50 | Styrene- | 63 | 1.5 | C | 78 | 12 |
| 1-15 | silicon | | | | | butadiene | | | | | |
| | | | | | | rubber | | | | | |
| | | | | | | emulsion | | | | | |
| Example | Silicon | 5 | 5.2 | 9.3 | 0.50 | Styrene- | 60 | 2 | C | 80 | 10 |
| 1-16 | oxide | | | | | acrylate | | | | | |
| | | | | | | emulsion | | | | | |
| | | | | | | (model | | | | | |
| | | | | | | number: | | | | | |
| | | | | | | LB-S420; | | | | | |
| | | | | | | solid | | | | | |
| | | | | | | content: | | | | | |
| | | | | | | 46 wt %) | | | | | |
| Compar- | Pure | 5 | 5.2 | 5.1 | 0.58 | Styrene- | 66 | 1 | C | 74 | 14.5 |
| ative | silicon | | | | | butadiene | | | | | |
| Example | | | | | | rubber | | | | | |
| 1-1 | | | | | | emulsion | | | | | |
| Compar- | Pure | 5 | 5.2 | 9.3 | 0.50 | Polyacrylic | 68 | 0.5 | C | 75 | 15 |
| ative | silicon | | | | | acid | | | | | |
| Example | | | | | | | | | | | |
| 1-2 | | | | | | | | | | | |
| Compar- | Pure | 30 | 31.2 | 9.3 | 0.50 | Styrene- | 67 | 1 | C | 73 | 16 |
| ative | silicon | | | | | butadiene | | | | | |
| Example | | | | | | rubber | | | | | |
| 1-3 | | | | | | emulsion | | | | | |
| Compar- | / | / | / | / | / | / | 66 | 1 | C | 77 | 13 |
| ative | | | | | | | | | | | |
| Example | | | | | | | | | | | |
| 1-4 | | | | | | | | | | | |
| Compar- | Pure | 5 | 5.2 | 9.3 | 0.50 | Styrene- | 65 | 1.5 | C | 77 | 12 |
| ative | silicon | | | | | butadiene | | | | | |
| Example | | | | | | rubber | | | | | |
| 1-5 | | | | | | emulsion | | | | | |
| Compar- | / | / | / | / | / | / | 65 | 1 | C | 77 | 13 |
| ative | | | | | | | | | | | |
| Example | | | | | | | | | | | |
| 1-6 | | | | | | | | | | | |
| Compar- | Pure | 17.5 | 18.2 | 7.2 | 0.54 | Styrene- | 64.5 | 1.5 | C | 75 | 14 |
| ative | silicon | | | | | butadiene | | | | | |
| Example | | | | | | rubber | | | | | |
| 1-7 | | | | | | emulsion | | | | | |

Note:
“/” in the Table indicates there are no related preparation parameters.

It can be seen from Examples 1-1 to 1-16 and Comparative examples 1-1 to 1-7 that in the lithium-ion battery in these examples of this application, the negative electrode plate includes the first active substance layer and the second active substance layer located between the negative electrode current collector and the first active substance layer, the first active substance layer includes the PAA binder, the second active substance layer includes the SBR binder, and the first silicon material in the first active substance layer and the second silicon material in the second active substance layer satisfy that the particle size D1 of the first silicon material is less than the particle size D2 of the second silicon material and the percentage P1 of the first silicon material is greater than the percentage P2 of the second silicon material, so that the lithium-ion battery has lower maximum discharge temperature at 4 C, better lithium precipitation resistance and cycling capacity retention performance, as well as lower cycling swelling rate. It can be seen from Example 1-1, Comparative examples 1-1 to 1-5, Examples 1-12 and 1-13, and Comparative examples 1-6 and 1-7 that when the particle size D1 of the first silicon material is greater than the particle size D2 of the second silicon material, or the first active substance layer adopts the SBR binder and the second active substance layer adopts the PAA binder, or only a single first active substance layer or a single second active substance layer is applied, the lithium-ion battery has higher maximum discharge temperature at 4 C, lower lithium precipitation level and cycling capacity retention rate, as well as higher cycling swelling rate. The foregoing results indicate that the lithium-ion battery using the negative electrode plate of this application has good kinetic performance and cycling stability.

The particle sizes of silicon materials typically affect the kinetic performance and cycling stability of lithium-ion batteries. It can be seen from Examples 1-1 to 1-5 and Examples 1-12 and 1-13 that the lithium-ion battery in which the particle sizes D1 and G1 of the first silicon material and the particle sizes D2 and G2 of the second silicon material are controlled to be within the ranges provided in this application has lower maximum discharge temperature at 4 C, better lithium precipitation resistance and cycling capacity retention rate, as well as lower cycling swelling rate. This indicates that the lithium-ion battery has better kinetic performance and cycling stability.

The percentages of silicon materials typically affect the kinetic performance and cycling stability of lithium-ion batteries. It can be seen from Examples 1-1 and Examples 1-6 to 1-15 that the lithium-ion battery in which the percentages P1 and A1 of the first silicon material and the percentages P2 and A2 of the second silicon material are controlled to be within the ranges provided in this application has lower maximum discharge temperature at 4 C, better lithium precipitation resistance and cycling capacity retention rate, as well as lower cycling swelling rate. This indicates that the lithium-ion battery has better kinetic performance and cycling stability.

The types of the first binder, the first silicon material, the second binder, and the second silicon material typically affect the kinetic performance and cycling stability of lithium-ion batteries. It can be seen from Example 1-1 and Example 1-16 that the lithium-ion battery using the first binder, first silicon material, second binder, and second silicon material of the types within the range provided in this application has lower maximum discharge temperature at 4 C, better lithium precipitation resistance and cycling capacity retention rate, as well as lower cycling swelling rate. This indicates that the lithium-ion battery has better kinetic performance and cycling stability.

TABLE 2

| | | | | | | | | | | | Maximum | | | | |
|---|---|---|---|---|---|---|---|---|---|---|---|---|---|---|---|
| | | | | | | | | | | | discharge | | | Cycling | |
| | | | | | | | | | | | temper- | Lithium | | capacity | Cycling |
| | First active substance layer | | | | | Second active substance layer | | | | | ature | precip- | | retention | swelling |
| | N1 | F1 | C1 | P1 | S1 | N2 | F2 | C2 | P2 | S2 | at 4 C | itation | | rate | rate |
| | (%) | (%) | (%) | (%) | (%) | (%) | (%) | (%) | (%) | (%) | (° C.) | level | | (%) | (%) |
| Example 1-1 | 3 | 0.5 | 0.5 | 30 | 66 | 2.8 | 0.7 | 0.5 | 5 | 91 | 60 | 2 | C | 80 | 10 |
| Example 2-1 | 1 | 0.5 | 0.5 | 28 | 70 | 2.8 | 0.7 | 0.5 | 5 | 91 | 58 | 2.5 | C | 81 | 10 |
| Example 2-2 | 7 | 0.5 | 0.5 | 20 | 72 | 2.8 | 0.7 | 0.5 | 5 | 91 | 62 | 1.5 | C | 79 | 9 |
| Example 2-3 | 10 | 0.5 | 0.5 | 19 | 70 | 2.8 | 0.7 | 0.5 | 5 | 91 | 63 | 1.5 | C | 78 | 8.5 |
| Example 2-4 | 3 | 0.1 | 0.5 | 29 | 67.4 | 2.8 | 0.7 | 0.5 | 5 | 91 | 60 | 2 | C | 79.5 | 10 |
| Example 2-5 | 3 | 3 | 0.5 | 21.5 | 72 | 2.8 | 0.7 | 0.5 | 5 | 91 | 59.5 | 2 | C | 80 | 10 |
| Example 2-6 | 3 | 5 | 0.5 | 20 | 71.5 | 2.8 | 0.7 | 0.5 | 5 | 91 | 59 | 2.5 | C | 79 | 10 |
| Example 2-7 | 3 | 0.5 | 0.1 | 29 | 67.4 | 2.8 | 0.7 | 0.5 | 5 | 91 | 61 | 1.5 | C | 80 | 10 |
| Example 2-8 | 3 | 0.5 | 3 | 21.5 | 72 | 2.8 | 0.7 | 0.5 | 5 | 91 | 59 | 2 | C | 81 | 9 |
| Example 2-9 | 3 | 0.5 | 5 | 20 | 71.5 | 2.8 | 0.7 | 0.5 | 5 | 91 | 58.5 | 2.5 | C | 81 | 9 |
| Example 2-10 | 3 | 0.5 | 0.5 | 30 | 66 | 1 | 0.7 | 0.5 | 5 | 92.8 | 60 | 2 | C | 80 | 11 |
| Example 2-11 | 3 | 0.5 | 0.5 | 30 | 66 | 7 | 0.7 | 0.5 | 5 | 86.8 | 60 | 2 | C | 80.5 | 9 |
| Example 2-12 | 3 | 0.5 | 0.5 | 30 | 66 | 10 | 0.7 | 0.5 | 5 | 83.8 | 61 | 1.5 | C | 81 | 8.5 |
| Example 2-13 | 3 | 0.5 | 0.5 | 30 | 66 | 2.8 | 0.1 | 0.5 | 5 | 91.6 | 60 | 2 | C | 80 | 10 |
| Example 2-14 | 3 | 0.5 | 0.5 | 30 | 66 | 2.8 | 3 | 0.5 | 5 | 88.7 | 60 | 2 | C | 80 | 9.5 |
| Example 2-15 | 3 | 0.5 | 0.5 | 30 | 66 | 2.8 | 5 | 0.5 | 5 | 86.7 | 59 | 2 | C | 81 | 9 |
| Example 2-16 | 3 | 0.5 | 0.5 | 30 | 66 | 2.8 | 0.7 | 0.1 | 5 | 91.4 | 60.5 | 2 | C | 79 | 11 |
| Example 2-17 | 3 | 0.5 | 0.5 | 30 | 66 | 2.8 | 0.7 | 3 | 5 | 88.5 | 59.5 | 2 | C | 80 | 10 |
| Example 2-18 | 3 | 0.5 | 0.5 | 30 | 66 | 2.8 | 0.7 | 5 | 5 | 86.5 | 59 | 2.5 | C | 81 | 9 |

Typically, mass percentages of a dispersant, a binder, and a conductive agent in a negative electrode active substance layer also affect the kinetic performance and cycling stability of lithium-ion batteries. Referring to Table 2, it can be seen from Example 2-1 to Example 2-18 that synergistically controlling the foregoing parameters in the ranges provided in this application helps to achieve a lower maximum discharge temperature at 4 C and better lithium precipitation resistance and cycling capacity retention performance; in addition, the lithium-ion battery has lower cycling swelling rate. This indicates that the lithium-ion battery has better kinetic performance and cycling stability.

It should be noted that relational terms such as “first” and “second” herein are only used to distinguish one entity or operation from another entity or operation, and do not necessarily require or imply that there is any such actual relationship or order between these entities or operations. In addition, the terms “include”, “comprise”, or any of their variants are intended to cover a non-exclusive inclusion, such that a process, method, or article that includes a series of elements includes not only those elements but also other elements that are not expressly listed, or further includes elements inherent to such process, method, or article.

The foregoing descriptions are merely preferred embodiments of this application, and are not intended to limit this application. Any modification, equivalent replacement, improvement, and the like made without departing from the spirit and principle of this application shall fall within the protection scope of this application.

What is claimed is:

1. A negative electrode plate, comprising a negative electrode current collector, a first active substance layer, and a second active substance layer; the first active substance layer and the second active substance layer are disposed on at least one surface of the negative electrode current collector; wherein in a thickness direction of the negative electrode plate, the second active substance layer is disposed between the negative electrode current collector and the first active substance layer;
the first active substance layer comprises a first active material and a first binder, the first active material comprises a first silicon material, and the first binder comprises a polyacrylic acid binder;
the second active substance layer comprises a second active material and a second binder, the second active material comprises a second silicon material, and the second binder comprises a styrene-butadiene rubber binder;
a mass percentage of the first silicon material in the first active substance layer is P1, and a mass percentage of the second silicon material in the second active substance layer is P2, wherein P2<P1; and
a particle size Dᵥ50 of the first silicon material is D1, and a particle size Dᵥ50 of the second silicon material is D2, wherein D1<D2.

2. The negative electrode plate according to claim 1, wherein 0.1%≤P2<P1≤30%.

3. The negative electrode plate according to claim 1, wherein 1 μm≤D1<D2≤30 μm.

4. The negative electrode plate according to claim 1, wherein the first active substance layer further comprises a first dispersant, the first dispersant comprises a first carboxymethyl cellulose dispersant, and a mass percentage F1 of the first dispersant in the first active substance layer is 0.1% to 5%; and/or,
the second active substance layer further comprises a second dispersant, the second dispersant comprises a second carboxymethyl cellulose dispersant, and a mass percentage F2 of the second dispersant in the second active substance layer is 0.1% to 5%.

5. The negative electrode plate according to claim 1, wherein 1 μm≤D1≤8 μm, and/or, 8 μm<D2≤30 μm.

6. The negative electrode plate according to claim 1, wherein a ratio of the particle size Dᵥ50 to a particle size Dᵥ90 of the first silicon material is G1, satisfying 0.55<G1≤0.7; and/or,
a ratio of the particle size Dᵥ50 to a particle size Dᵥ90 of the second silicon material is G2, satisfying 0.5≤G2≤0.55.

7. The negative electrode plate according to claim 1, wherein the first active material further comprises a first graphite, and based on a total mass of the first active material, a mass percentage A1 of the first silicon material is 1% to less than 100%, and a mass percentage B1 of the first graphite is greater than 0% to 99%; and/or,
the second active material further comprises a second graphite, and based on a total mass of the second active material, a mass percentage A2 of the second silicon material is greater than 0% to 99%, and a mass percentage B2 of the second graphite is 1% to less than 100%.

8. The negative electrode plate according to claim 7, wherein the mass percentage A1 of the first silicon material is 15% to less than 100%, and the mass percentage B1 of the first graphite is greater than 0% to 85%; and/or,
the mass percentage A2 of the second silicon material is 1% to 15%, and the mass percentage B2 of the second graphite is 85% to 99%.

9. The negative electrode plate according to claim 1, wherein a mass percentage N1 of the first binder in the first active substance layer is 1% to 10%; and/or,
a mass percentage N2 of the second binder in the second active substance layer is 1% to 10%.

10. The negative electrode plate according to claim 1, wherein the first active substance layer further comprises a first conductive agent, and a mass percentage C1 of the first conductive agent in the first active substance layer is 0.1% to 5%; and/or,
the second active substance layer further comprises a second conductive agent, and a mass percentage C2 of the second conductive agent in the second active substance layer is 0.1% to 5%.

11. The negative electrode plate according to claim 1, wherein the negative electrode plate satisfies at least one of the following characteristics:
(1) the polyacrylic acid binder comprises at least one of polyacrylic acid or polymethacrylic acid;
(2) the styrene-butadiene rubber binder comprises at least one of styrene-butadiene rubber emulsion, styrene-acrylate emulsion, or pure acrylate emulsion; or
(3) the first silicon material and the second silicon material each independently comprise at least one of pure silicon, a silicon alloy material, a silicon-carbon composite material, or a silicon oxide.

12. A secondary battery, comprising a negative electrode plate, the negative electrode plate comprising a negative electrode current collector, a first active substance layer and a second active substance layer; the first active substance layer and the second active substance layer are disposed on at least one surface of the negative electrode current collector; wherein in a thickness direction of the negative electrode plate, the second active substance layer is disposed between the negative electrode current collector and the first active substance layer;
the first active substance layer comprises a first active material and a first binder, the first active material comprises a first silicon material, and the first binder comprises a polyacrylic acid binder;
the second active substance layer comprises a second active material and a second binder, the second active material comprises a second silicon material, and the second binder comprises a styrene-butadiene rubber binder;
a mass percentage of the first silicon material in the first active substance layer is P1, and a mass percentage of the second silicon material in the second active substance layer is P2, wherein P2<P1; and
a particle size Dᵥ50 of the first silicon material is D1, and a particle size Dᵥ50 of the second silicon material is D2, wherein D1<D2.

13. The secondary battery according to claim 12, wherein 0.1%≤P2<P1≤30%.

14. The secondary battery according to claim 12, wherein 1 μm≤D1<D2≤30 μm.

15. The secondary battery according to claim 12, wherein the first active substance layer further comprises a first dispersant, the first dispersant comprises a first carboxymethyl cellulose dispersant, and a mass percentage F1 of the first dispersant in the first active substance layer is 0.1% to 5%; and/or,
the second active substance layer further comprises a second dispersant, the second dispersant comprises a second carboxymethyl cellulose dispersant, and a mass percentage F2 of the second dispersant in the second active substance layer is 0.1% to 5%.

16. The secondary battery according to claim 12, wherein 1 μm≤D1≤8 μm, and/or, 8 μm<D2≤30 μm.

17. The secondary battery according to claim 12, wherein a ratio of the particle size Dᵥ50 to a particle size Dᵥ90 of the first silicon material is G1, satisfying 0.55<G1≤0.7; and/or,
a ratio of the particle size Dᵥ50 to a particle size Dᵥ90 of the second silicon material is G2, satisfying 0.5≤G2≤0.55.

18. The secondary battery according to claim 12, wherein the first active material further comprises a first graphite, and based on a total mass of the first active material, a mass percentage A1 of the first silicon material is 1% to less than 100%, and a mass percentage B1 of the first graphite is greater than 0% to 99%; and/or,
the second active material further comprises a second graphite, and based on a total mass of the second active material, a mass percentage A2 of the second silicon material is greater than 0% to 99%, and a mass percentage B2 of the second graphite is 1% to less than 100%.

19. The secondary battery according to claim 18, wherein the mass percentage A1 of the first silicon material is 15% to less than 100%, and the mass percentage B1 of the first graphite is greater than 0% to 85%; and/or,
the mass percentage A2 of the second silicon material is 1% to 15%, and the mass percentage B2 of the second graphite is 85% to 99%.

20. An electronic apparatus, comprising a secondary battery, the secondary battery comprising a negative electrode plate, the negative electrode plate comprising a negative electrode current collector, a first active substance layer and a second active substance layer; the first active substance layer and the second active substance layer are disposed on at least one surface of the negative electrode current collector; wherein in a thickness direction of the negative electrode plate, the second active substance layer is disposed between the negative electrode current collector and the first active substance layer;
the first active substance layer comprises a first active material and a first binder, the first active material comprises a first silicon material, and the first binder comprises a polyacrylic acid binder;
the second active substance layer comprises a second active material and a second binder, the second active material comprises a second silicon material, and the second binder comprises a styrene-butadiene rubber binder;
a mass percentage of the first silicon material in the first active substance layer is P1, and a mass percentage of the second silicon material in the second active substance layer is P2, wherein P2<P1; and
a particle size Dᵥ50 of the first silicon material is D1, and a particle size Dᵥ50 of the second silicon material is D2, wherein D1<D2.
